(19) United States
(12) Patent Application Publication
(10) Pub. No.: US 2026/0113204 A1
(43) Pub. Date: Apr. 23, 2026

(54) ELECTRONIC DEVICE, CONTROL METHOD, AND NON-TRANSITORY COMPUTER-READABLE STORAGE MEDIUM

(71) Applicant: CANON KABUSHIKI KAISHA, Tokyo (JP)

(72) Inventor: KOJI INAGAKI, Tokyo (JP)

(21) Appl. No.: 19/352,585

(22) Filed: Oct. 8, 2025

(30) Foreign Application Priority Data
Oct. 17, 2024 (JP) 2024-182172

(51) Int. Cl. H04L 9/32

(52) U.S. Cl. CPC H04L 9/3263

(57) ABSTRACT

An electronic device includes a control unit configured to, in a case where connection between the electronic device and a first server outside the electronic device is to be started, control to execute first transmission processing of transmitting, to the first server, information for requesting start of communication by a predetermined protocol for performing encrypted communication, and if the communication by the predetermined protocol is started between the electronic device and the first server based on the first transmission processing, control to execute first reception processing of receiving, from the first server, second root certificate data for verifying certificate data from a second server different from the first server even without an operation from a user after execution of the first transmission processing.

### BACKGROUND

### Field of the Technology

The present disclosure relates to an electronic device, a control method, and a non-transitory computer-readable storage medium.

### Description of the Related Art

Currently, software called firmware is installed in an information processing apparatus such as a printer, a digital still camera, or a portable music player. Firmware is software that is installed in a device to control hardware implemented in a device such as a printer or a digital still camera. For example, a Basic Input Output System (BIOS) in a personal computer is a type of firmware.

In addition, firmware can be changed (updated) later to add a function or correct malfunction. To update firmware, a method is used in which a recording medium such as a CD-ROM in which firmware of new version is written is distributed, the firmware is read out from the storage medium, and firmware of earlier version installed in a device is updated. With the spread of networks such as the Internet, a service of distributing firmware of new version via a network is commonplace.

On the other hand, an information processing apparatus such as a printer, a digital still camera, or a portable music player has a function of connecting the apparatus itself to the Internet. Therefore, to ensure security of the apparatus to cope with encrypted communication such as Transport Layer Security (TLS), there is a need to install, on such information processing apparatus, an electronic certificate that is conventionally for a computer.

The electronic certificate is used to, for example, verify authenticity of an electronic signature or the like, and is generally issued from a trusted third party certification body (to be referred to as a certificate authority hereinafter). By using the issued electronic certificate, for example, it is possible to prove that a server to be accessed can perform encrypted communication and to prove that a provider of a Web site actually exists.

In addition, the electronic certificate includes a so-called root certificate that is signed and issued by a certificate authority to certify authenticity of the certificate. Normally, when performing encrypted communication, a Web browser, a network controller, or the like holds a root certificate issued in advance by the certificate authority. When performing communication with a Web site (Web server), it is checked whether a server certificate transmitted from the Web site (Web server) is authentic. When the authenticity of the server certificate is checked, it is determined first whether the server certificate issued by the certificate authority is authentic. If the server certificate is authentic, it is checked whether the certificate authority itself can be trusted. At this time, if the user holds, in advance, a root certificate electronically signed by the certificate authority, the Web site (Web server) can be regarded to be trusted.

Note that the root certificate or the server certificate normally has an expiration date. Therefore, there is provided a technique for performing an updating operation of such a certificate (Japanese Patent Laid-Open No. 2006-239930). Furthermore, there is provided a technique of executing firmware acquisition processing and updating processing, thereby performing an operation of updating data of an electronic certificate formed as a part of firmware (Japanese Patent Laid-Open No. 2008-129788).

### SUMMARY

The present disclosure provides an electronic device, a control method, and a non-transitory computer-readable storage medium that improve security and usability when acquiring certificate data.

The present disclosure in one aspect provides an electronic device comprising at least one memory and at least one processor which function as a control unit configured to, in a case where connection between the electronic device and a first server outside the electronic device is to be started, control to execute first transmission processing of transmitting, to the first server, information for requesting start of communication by a predetermined protocol for performing encrypted communication, and if the communication by the predetermined protocol is started between the electronic device and the first server based on the first transmission processing, control to execute first reception processing of receiving, from the first server, second root certificate data for verifying certificate data from a second server different from the first server even without an operation from a user after execution of the first transmission processing.

Features of the present disclosure will become apparent from the following description of embodiments with reference to the attached drawings. The following description of embodiments are described by way of example.

### BRIEF DESCRIPTION OF THE DRAWINGS

FIG. 1 is a view showing the configuration of a system;

FIGS. 2A and 2B are block diagrams showing the configurations of a printer and an external server;

FIG. 3 is a view showing the data storage configuration in the memory of the printer;

FIG. 4 is a view showing the configuration of an updating firmware file;

FIG. 5 is a view showing the software configuration of the printer;

FIG. 6 is a sequence chart for explaining root certificate updating processing;

FIG. 7 is a view showing a communication setting window;

FIG. 8 is a sequence chart for explaining firmware updating processing;

FIG. 9 is a sequence chart for explaining processing executed between apparatuses; and

FIG. 10 is a sequence chart for explaining processing executed between apparatuses.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

In Japanese Patent Laid-Open No. 2006-239930 or 2008-129788, since encrypted communication is not performed in communication when acquiring a root certificate, it is necessary to improve confidentiality and integrity of data. Furthermore, in Japanese Patent Laid-Open No. 2008-129788, to acquire a root certificate, a user operation for acquiring the root certificate is needed and, therefore, it is necessary to improve usability.

According to the present disclosure, it is possible to improve security and usability when acquiring certificate data.

### First Embodiment

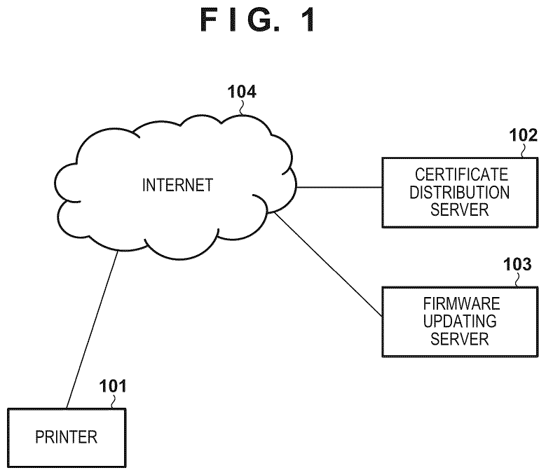

This embodiment will now be described using a printer as an example of an information processing apparatus. FIG. 1 is a view showing an example of the configuration of a print system including a printer as an information processing apparatus according to this embodiment. A printer 101 is connected to a network (not shown) such as a Local Area Network (LAN). The LAN is connected to the Internet 104 via a router (not shown), and the printer 101 can communicate with a certificate distribution server 102 and a firmware updating server 103, which are Hyper Text Transfer Protocol (HTTP) servers (Web servers) on the Internet. Note that the LAN and the Internet 104 are examples of the network. The network may be a wired network, a wireless network, or a network including both in mixture. A server (for example, a content server) other than the certificate distribution server 102 and the firmware updating server 103 may be formed outside the printer 101.

The certificate distribution server 102 is a server configured to update a root certificate installed in the printer 101, and a latest root certificate is stored in the certificate distribution server 102. The printer 101 can access the certificate distribution server 102 via the Internet 104 and download the latest root certificate. Note that, for example, if the root certificate has expired, the expiration date of the root certificate is past, or an external server the printer 101 supports has increased, the latest root certificate is stored in the certificate distribution server 102. Note that the external server is a server outside the printer 101, and examples are the certificate distribution server 102 and the firmware updating server 103.

The firmware updating server 103 is a server configured to update firmware data of the printer 101. In other words, it is a server as the acquisition destination from which the printer 101 acquires data used to update the firmware data. A firmware file used to update firmware data is stored in the firmware updating server 103, and firmware data of new version is included in the firmware file. The printer 101 can, for example, download firmware data from the firmware updating server 103 and update firmware data of earlier version already installed in the printer 101 to the firmware data of new version.

HTTP communication using a predetermined protocol, for example, HTTP is performed between the certificate distribution server 102 and the printer 101 and between the firmware updating server 103 and the printer 101. In this embodiment, to implement securer HTTP communication, TLS communication using Transport Layer Security (TLS) is performed. To confirm the server certificate of each of the certificate distribution server 102 and the firmware updating server 103, the printer 101 holds the root certificate of a root authority that is a trusted third party. The root certificate is an electronic certificate that is signed and issued by the authority itself to certify the authenticity of the certificate. The root certificate is used to check whether a server certificate transmitted from a Web server is authentic. A description of the function of each of the certificate distribution server 102 and the firmware updating server 103 as an HTTP server will be omitted. Data representing a root certificate communicated between apparatuses will be referred to as root certificate data, and data representing a server certificate communicated between apparatuses will be referred to as server certificate data hereinafter.

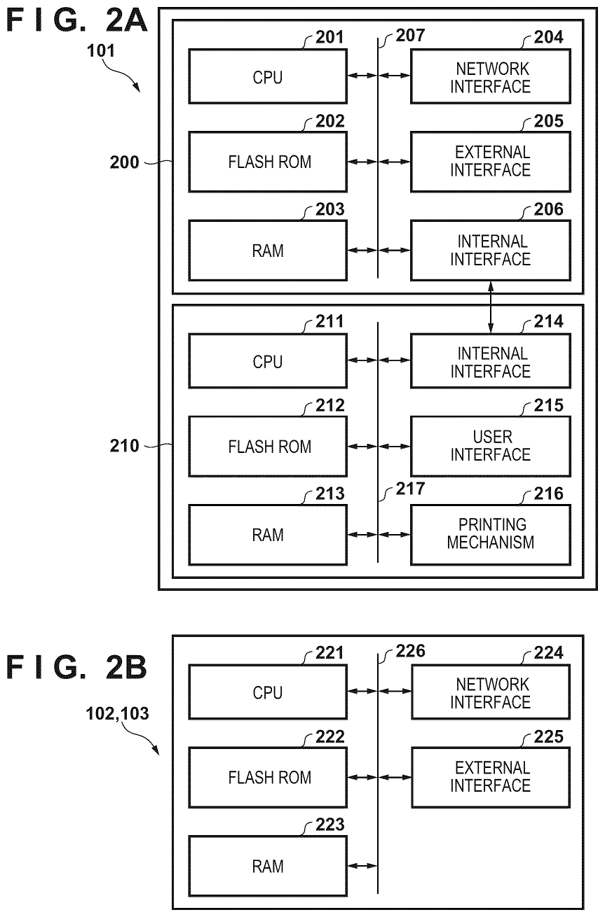

Examples of the configurations of the printer 101 and an external server will be described next with reference to FIGS. 2A and 2B. FIG. 2A is a block diagram showing an example of the internal configuration of the printer 101, and FIG. 2B is a block diagram showing an example of the internal configuration of an external server.

The printer 101 includes a controller 200 that performs control associated with a network, and an engine controller 210 that controls the main body of the printer 101. The controller 200 includes a CPU 201 that controls the entire controller 200. A flash ROM 202 is a computer-readable storage unit that stores firmware data or root certificate data. A RAM 203 is a computer-readable storage unit used as various kinds of work areas and a predetermined management data storage area. For example, based on the firmware data stored in the flash ROM 202 and the management data stored in the RAM 203, the CPU 201 implements the operation of the printer 101 using the RAM 203 as a work area.

A network interface 204 is an interface unit configured to connect the printer 101 and the LAN. Note that in this embodiment, as an example, the printer 101 is connected to the LAN by Ethernet®. The network interface 204 can have a configuration corresponding to a wired network or a wireless network. FIG. 2A shows a single network interface 204, but a plurality of network interfaces 204 may be provided. For example, interfaces of a plurality of different communication forms including short distance wireless communication may be formed. An external interface 205 is a device interface of, for example, a Universal Serial Bus (USB). For example, the printer 101 can be connected to, for example, a digital still camera (not shown) with a USB host interface via the external interface 205. An internal interface 206 is connected to the engine controller 210, and data transmission/reception can be performed between the controller 200 and the engine controller 210. Note that the above-described blocks in the controller 200 are connected to a system bus 207 of the controller 200 and can communicate with each other.

The engine controller 210 includes a CPU 211 that controls the entire engine controller 210. A flash ROM 212 is a storage unit that stores firmware data. A RAM 213 is a storage unit used as various kinds of work areas. For example, based on the firmware data stored in the flash ROM 212, the CPU 211 implements the operation of the printer 101 using the RAM 213 as a work area.

An internal interface 214 is connected to the internal interface 206 of the controller 200, and data transmission/reception can be performed between the controller 200 and the engine controller 210. A user interface 215 is configured to include an input device such as a hardware key provided on the operation panel (not shown) of the printer 101, and a display device that displays information. The user interface 215 inputs an instruction of a user to the printer 101 and displays the status of the printer 101 or various kinds of user interface screens. Note that the user interface 215 may be formed as a touch panel including software keys. A printing mechanism 216 is a mechanical part configured to form (print) an image on a print medium such as paper, and operates under the control of the CPU 211. Various printing methods such as an inkjet printing method and an electrophotographic method can be employed for the printing mechanism 216. Note that the above-described blocks in the engine controller 210 are connected to a system bus 217 of the engine controller 210 and can communicate with each other.

The operation of the printer 101 according to this embodiment can be implemented by any one of the CPU 201 and the CPU 211, and may be implemented by cooperation of the CPU 201 and the CPU 211. In this embodiment, as an example, a description will be made assuming that the operation of the printer 101 is implemented by the CPU 201 reading out a program stored in the flash ROM 202 to the RAM 203 and executing it.

FIG. 2B shows an example of the internal configuration of an external server. Here, the external server is, for example, the certificate distribution server 102 or, for example, the firmware updating server 103. In this embodiment, a description will be made assuming that the certificate distribution server 102 and the firmware updating server 103 commonly have the configuration shown in FIG. 2B. However, the configurations of the certificate distribution server 102 and the firmware updating server 103 may be different, and each server can have a configuration according to functions that the server can execute. In the explanation of FIG. 2B, the certificate distribution server 102 will be described as a representative example of the certificate distribution server 102 and the firmware updating server 103.

The certificate distribution server 102 includes a CPU 221 that controls the entire certificate distribution server 102. A flash ROM 222 is a computer-readable storage unit that stores an updating firmware file to be described later. A RAM 223 is a computer-readable storage unit used as various kinds of work areas and a predetermined management data storage area. For example, the CPU 221 implements the operation of the certificate distribution server 102 according to this embodiment by reading out a program stored in the flash ROM 222 to the RAM 223 and executing it.

A network interface 224 is an interface unit configured to connect the certificate distribution server 102 and the LAN. Note that in this embodiment, as an example, the certificate distribution server 102 is connected to the LAN by Ethernet®. The network interface 224 can have a configuration corresponding to a wired network or a wireless network. FIG. 2B shows a single network interface 224, but a plurality of network interfaces 224 may be provided. For example, interfaces of a plurality of different communication forms including short distance wireless communication may be formed. An external interface 225 is a device interface of, for example, a Universal Serial Bus (USB). Note that the above-described blocks are connected to a system bus 226 and can communicate with each other.

The data storage configuration (memory configuration) of the storage area of the flash ROM 202 of the controller 200 of the printer 101 will be described next. Note that only the storage area of controller firmware data used to operate the controller 200 will be described here, and a description of the storage area of engine controller firmware data used to operate the engine controller 210 will be omitted. However, the description of the storage area of the controller firmware data can also be applied to the storage area of the engine controller firmware data. The controller firmware data will simply be referred to as firmware data hereinafter.

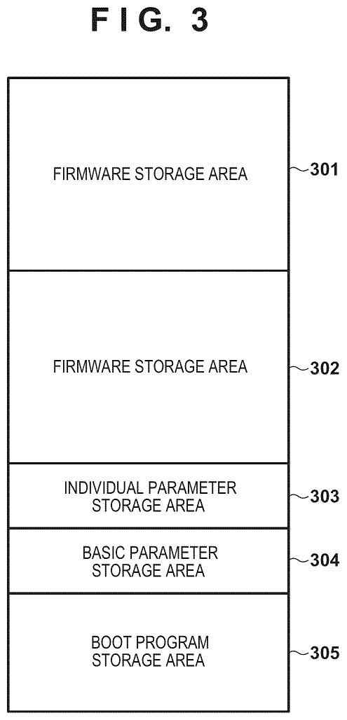

FIG. 3 is a view showing an example of the data storage configuration of the flash ROM 202 of the printer 101. The flash ROM 202 of the controller 200 includes a firmware storage area 301 and a firmware storage area 302 as the storage area of firmware data. In a situation of the printer 101 shipped, firmware data of initial version is stored in one of the two storage areas. At that time, no firmware data is stored in the other storage area.

On the other hand, if the printer 101 executes firmware updating processing to be described later and acquires new firmware data, the acquired new firmware data is stored in the other of the two storage areas, where no data is stored. If the printer 101 further executes firmware updating processing, the new firmware data is stored (that is, overwritten) in the area where firmware data that is not used at that time is stored.

An individual parameter storage area 303 is an area to store device information or setting information specific to the printer 101. The device information is, for example, an IP address, and the setting information is, for example, information indicating settings such as a paper size associated printing. A basic parameter storage area 304 is an area to store information of firmware data to be activated by a boot program. For example, the version information of firmware data stored in each of the firmware storage area 301 and the firmware storage area 302 is stored in the basic parameter storage area 304.

A boot program storage area 305 is an area in which a boot program configured to activate firmware data for operating the controller 200 is stored. The boot program stored in the boot program storage area 305 refers to the version information of firmware data stored in the individual parameter storage area 303 and decides firmware data to be activated. For example, firmware data corresponding to newer version information is decided. The boot program then executes activation processing of the decided firmware data.

In this embodiment, root certificate data is stored in each of the firmware storage area 301 and the firmware storage area 302, in addition to the firmware data. Here, the root certificate data is, for example, root certificate data necessary for verifying server certificate data and executing secure communication between the printer 101 and the certificate distribution server 102. Also, the root certificate data is, for example, root certificate data necessary for verifying server certificate data and executing secure communication between the printer 101 and the firmware updating server 103.

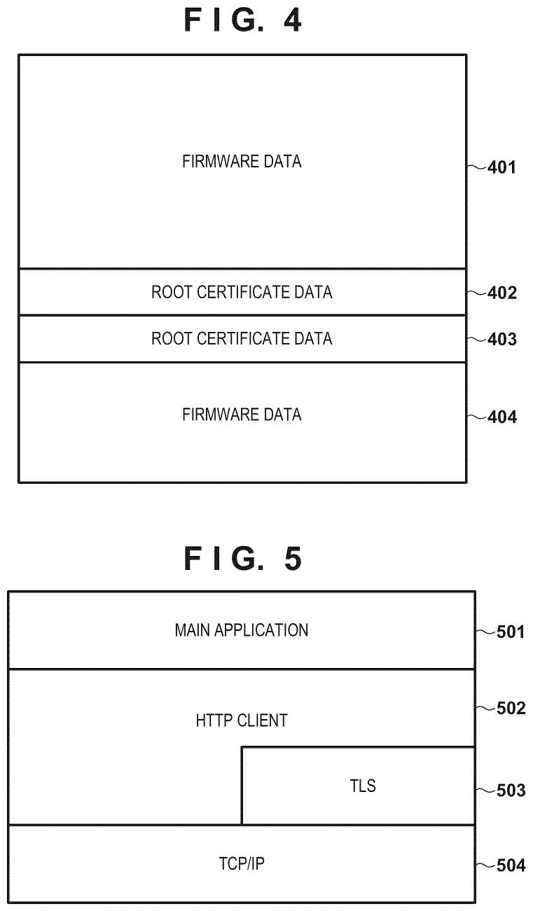

Next, the configuration of an updating firmware file including firmware data will be described with reference to FIG. 4. FIG. 4 is a view conceptually showing an example of an updating firmware file configuration including firmware data, which is stored as a binary format in the flash ROM 222 of the firmware updating server 103. As described above, in the firmware updating server 103, updating firmware files used to update firmware data of the controller 200 and the engine controller 210 of the printer 101 are stored. Here, only the updating firmware file used to update the firmware data for operating the controller 200 will be described. Note that the description of the updating firmware file used to update the firmware data for operating the controller 200 can be applied to the updating firmware file used to update the firmware data for operating the engine controller 210.

The updating firmware file is one file in a binary format, and includes firmware data 401 and 404 for operating the controller 200. Also, the updating firmware file includes root certificate data 402 for verifying server certificate data and executing secure communication between the printer 101 and the certificate distribution server 102. In other words, the root certificate data 402 is root certificate data for verifying server certificate data from the certificate distribution server 102. In addition, the updating firmware file includes root certificate data 403 for verifying server certificate data and executing secure communication between the printer 101 and the firmware updating server 103. In other words, the root certificate data 403 is root certificate data for verifying server certificate data from the firmware updating server 103.

FIG. 4 shows a state in which two types of root certificate data, that is, the root certificate data 402 and 403 are included as the root certificate data. However, if a server other than the certificate distribution server 102 and the firmware updating server 103 is formed as an external server, root certificate data for verifying server certificate data from that server may be included. For example, root certificate data for verifying server certificate data from a content server may be included in the updating firmware file.

In the firmware data 401, pointers used to specify the storage positions of the root certificate data 402 and 403 in the updating firmware file are described. The CPU 221 of the firmware updating server 103 refers to the pointers, thereby specifying where the root certificate data 402 and 403 are stored in the updating firmware file. The root certificate data 402 and 403 each include specific information specific to each root certificate, such as a type, certificate authority information, revision information, and expiration date of each root certificate data.

The firmware storage area 301 and the firmware storage area 302 shown in FIG. 3 each have the same data storage configuration as the updating firmware file shown in FIG. 4. That is, if the printer 101 acquires an updating firmware file from the firmware updating server 103 and stores it in the firmware storage area 301 or the firmware storage area 302, the firmware storage area 301 and the firmware storage area 302 have the same configuration as in FIG. 4.

Note that in FIG. 4, the root certificate data 402 and 403 are arranged between the firmware data 401 and the firmware data 404. However, if firmware data and root certificate data are integrated in the file configuration, the configuration is not limited to that shown in FIG. 4.

As described above, in this embodiment, root certificate data corresponding to a root certificate and firmware data are integrated in the file configuration of the updating firmware file. In other words, the root certificate data is held as a part of the updating firmware file. For this reason, when the printer 101 acquires the updating firmware file, the root certificate data is acquired together with the firmware data when downloading the firmware data. In other words, to acquire the root certificate data, the printer 101 need only execute firmware updating processing of the controller 200. On the other hand, in this embodiment, without performing firmware updating processing, the printer 101 acquires the root certificate data from the certificate distribution server 102, thereby updating the two types of root certificate data, that is, the root certificate data for verifying server certificate data from the certificate distribution server 102 and the root certificate data for verifying server certificate data from the firmware updating server 103, which are held in the printer 101. Note that the root certificate data for verifying server certificate data from the certificate distribution server 102 will sometimes be referred to as root certificate data corresponding to the certificate distribution server 102 hereinafter. Also, the root certificate data for verifying server certificate data from the firmware updating server 103 will sometimes be referred to as root certificate data corresponding to the firmware updating server 103.

Of software configurations of the controller 200 of the printer 101, a software configuration according to this embodiment will be described next with reference to FIG. 5. Note that software to be described below is included in firmware data.

FIG. 5 is a view showing an example of the software configuration of the controller 200 of the printer 101. A main application 501 is software used for main control of the controller 200. The main application 501 includes a module that executes processing requested by the certificate distribution server 102 and the firmware updating server 103. However, if the printer 101 can communicate with another external server, the main application 501 can appropriately include a module that executes processing requested by the server.

An HTTP client application 502 acquires root certificate data from the certificate distribution server 102 and an updating firmware file from the firmware updating server 103 by cooperating with the main application 501.

A TLS module 503 is invoked from the HTTP client application 502 and used when performing TLS communication between the printer 101 and the certificate distribution server 102 and between the printer 101 and the firmware updating server 103. Using the root certificate data corresponding to the certificate distribution server 102, which is stored in the flash ROM 202, the TLS module 503 confirms the reliability of server certificate data transmitted from the certificate distribution server 102 (verification of server certificate data). In addition, using the root certificate data corresponding to the firmware updating server 103, which is stored in the flash ROM 202, the TLS module 503 confirms the reliability of server certificate data transmitted from the firmware updating server 103.

A Transmission Control Protocol (TCP)/Internet Protocol (IP) stack 504 controls communication between the HTTP client application 502, the TLS module 503, and the network interface 204. This enables TCP/IP communication between the certificate distribution server 102 or the firmware updating server 103 and the printer 101. Note that if another external server that is not illustrated in FIG. 1 exists, the TCP/IP stack 504 enables TCP/IP communication between the external server and the printer 101.

As an example of processing executed in the above-described software configuration, processing in a case where firmware updating of a Uniform Resource Identifier (URI) format is instructed from the firmware updating server 103 will be described.

Assume that a URI indicating the location of an updating firmware file transmitted from the firmware updating server 103 to the printer 101 is “https://xxx.yyy.co.jp/index.html”. Such URI transmission is performed when, for example, latest firmware data is prepared in the firmware updating server 103. In a case of this URI, secure HTTP communication is necessary because of https. Since the acquired URI requests HTTP communication, the main application 501 transfers the information of the URI to the HTTP client application 502.

Since the URI indicated by the received information requests secure HTTP communication, the HTTP client application 502 requests the TLS module 503 to perform processing. As preparation for performing secure HTTP communication, the TLS module 503 starts communicating with the firmware updating server 103 while setting the location of the updating firmware file instructed by the URI as a communication destination. Here, actual communication is performed via the TCP/IP stack 504.

The TLS module 503 acquires server certificate data transmitted from the firmware updating server 103, and determines, using root certificate data corresponding to the firmware updating server 103 held in the printer 101, whether secure HTTP communication is possible. This determination is included in verification of server certificate data. If secure HTTP communication is possible as a result of the determination, the HTTP client application 502 executes communication. If secure HTTP communication is not possible, the HTTP client application 502 determines to perform communication in a nonsecure state or stop communication. Note that as will be described later, in this embodiment, verification of server certificate data is deliberately not executed in some cases. In this embodiment, the case where TLS communication is performed without executing verification of server certificate data is included in the case where secure HTTP communication is possible.

Root certificate updating processing by communication between the printer 101 and the certificate distribution server 102 and firmware updating processing by communication between the printer 101 and the firmware updating server 103 will be described next.

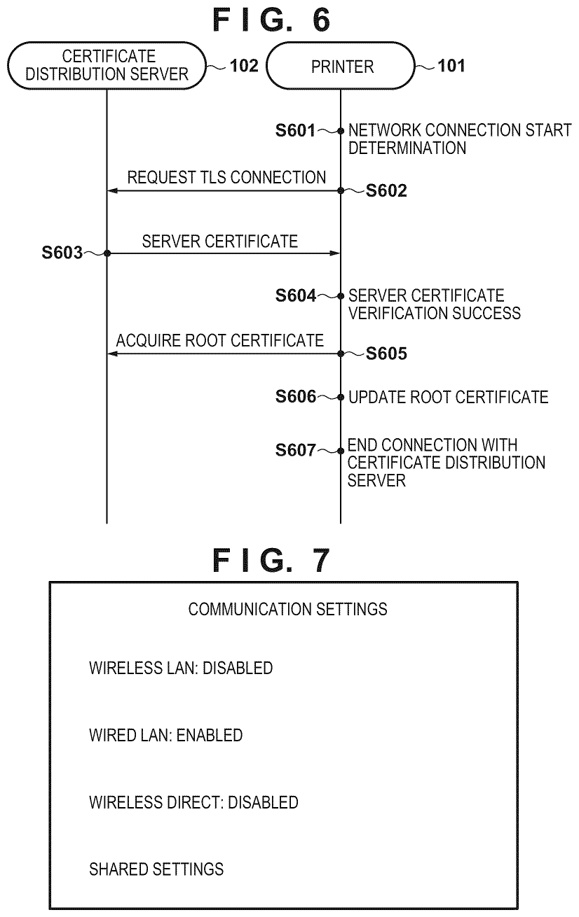

FIG. 6 is a sequence chart for explaining root certificate updating processing executed between the printer 101 and the certificate distribution server 102. The operation of the printer 101 shown in FIG. 6 is implemented by, for example, the CPU 201 reading out a program stored in the flash ROM 202 to the RAM 203 and executing it. Also, the operation of the certificate distribution server 102 shown in FIG. 6 is implemented by, for example, the CPU 221 of the certificate distribution server 102 reading out a program stored in the flash ROM 222 to the RAM 223 and executing it.

In S601, the CPU 201 of the printer 101 performs network connection start determination. The network connection start determination is processing of determining whether to perform communication between the printer 101 and the certificate distribution server 102 to perform root certificate updating processing. More specifically, for example, in a case where the user performs an operation of powering on the printer 101, if wired LAN communication or wireless LAN communication in an infrastructure mode (wireless LAN communication via an access point) is set enabled by a communication setting of the printer 101 and an IP address is added to the printer 101, it is determined to perform the communication between the printer 101 and the certificate distribution server 102. Alternatively, if, in the power-on state of the printer 101, a setting change operation of enabling network communication (enabling at least one of wired LAN communication and wireless LAN communication in the infrastructure mode) is performed from a state in which network communication is disabled (both wired LAN communication and wireless LAN communication in the infrastructure mode are disabled), network connection is started, and it is determined to perform communication between the printer 101 and the certificate distribution server 102. That is, the processing of S602 is performed when an operation as the factor for starting network connection, for example, an operation of powering on or an operation of enabling network communication is performed. FIG. 7 is a view showing an example of a communication setting screen displayed on the operation panel (not shown) of the user interface 215 of the printer 101. The communication setting screen in FIG. 7 shows an example in which the interface of wired LAN is set “enabled” by a user operation. Note that the setting items of the communication setting screen can be changed by a user operation. For example, based on setting the interface of wired LAN from “disabled” to “enabled” by a user operation, it is determined to perform the above-described communication between the printer 101 and the certificate distribution server 102.

In S602, the CPU 201 of the printer 101 requests TLS connection to the certificate distribution server 102. In other words, by the request of TLS connection to the certificate distribution server 102, TLS communication between the printer 101 and the certificate distribution server 102 is started. More specifically, for example, TLS hand shake is started by transmission processing of transmitting a ClientHello message.

In S603, the CPU 221 of the certificate distribution server 102 transmits server certificate data to the printer 101 in the process of TLS hand shake.

In S604, upon receiving the server certificate data from the certificate distribution server 102, the CPU 201 of the printer 101 verifies the received server certificate data using root certificate data corresponding to the certificate distribution server 102 held in the printer 101. The root certificate data held in the printer 101 at the time when the server certificate data is received from the certificate distribution server 102 in S603 will be referred to as “initial root certificate data” hereinafter.

As the verification of server certificate data, for example, it is determined using the initial root certificate data whether the sign of the server certificate data can be trusted. Note that the verification may be performed by another method. For example, verification may be performed based on a result of comparison between CommonName (CN) of the server certificate data and the domain name of the connection destination of the printer 101 or by confirming the expiration date of the server certificate data or confirming the presence/absence of expiration of the server certificate data. Here, assume that the result of the verification of the server certificate data in S604 is determined as success.

In S605, the CPU 201 of the printer 101 acquires latest root certificate data from the certificate distribution server 102 by TLS communication encrypted by TLS. Thus, in this embodiment, since root certificate data is acquired by TLS communication, it is possible to improve security associated with acquisition of root certificate data as compared to a case where it is acquired by a plain text.

In S606, the CPU 201 of the printer 101 updates the held initial root certificate data by the latest root certificate data acquired in S605. In S607, the CPU 201 of the printer 101 ends the TLS connection between the printer 101 and the certificate distribution server 102. The processing of S602 to S606 is processing automatically performed without the user operation to the printer 101. That is, after the operation as the factor for starting network connection is performed, the processing of S602 to S606 is automatically performed without the user operation.

In this embodiment, there exist root certificate data corresponding to the certificate distribution server 102 and root certificate data corresponding to the firmware updating server 103. In S605 of FIG. 6, the printer 101 acquires the two root certificate data from the certificate distribution server 102. In other words, in S605 of FIG. 6, reception processing of receiving the two root certificate data from the certificate distribution server 102 is performed. That is, the printer 101 acquires, from the certificate distribution server 102, the root certificate data corresponding to the certificate distribution server 102 and the root certificate data corresponding to the firmware updating server 103. In S606, the printer 101 updates the initial root certificate data corresponding to the certificate distribution server 102 by the root certificate data corresponding to the certificate distribution server 102 acquired in S605. Also, in S606, the printer 101 updates the initial root certificate data corresponding to the firmware updating server 103 by the root certificate data corresponding to the firmware updating server 103 acquired in S605. That is, in this embodiment, if the result of the verification of the server certificate data in S604 is determined as success, the printer 101 updates all initial root certificate data held at that time. Hence, if an external server that is not illustrated in FIG. 1 exists, root certificate data other than the two root certificate data may be updated. For example, in S605, the printer 101 may acquire, from the certificate distribution server 102, root certificate data for verifying server certificate data from another content server (not shown). In S606, the printer 101 may update initial root certificate data corresponding to the content server by the acquired root certificate data.

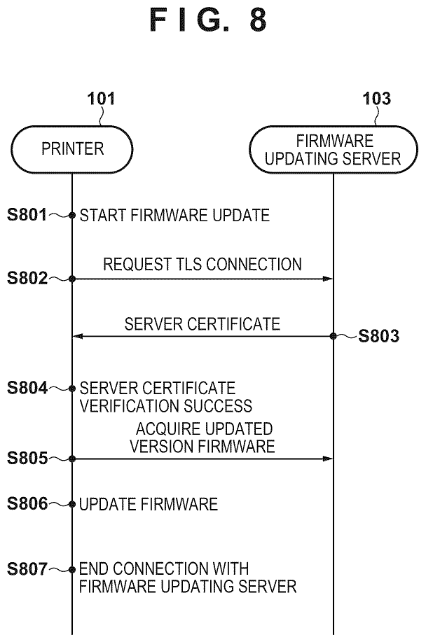

FIG. 8 is a sequence chart for explaining firmware updating processing executed between the printer 101 and the firmware updating server 103. The operation of the printer 101 shown in FIG. 8 is implemented by, for example, the CPU 201 reading out a program stored in the flash ROM 202 to the RAM 203 and executing it. Also, the operation of the firmware updating server 103 shown in FIG. 8 is implemented by, for example, the CPU 221 of the firmware updating server 103 reading out a program stored in the flash ROM 222 to the RAM 223 and executing it.

In S801, the CPU 201 of the printer 101 starts firmware updating processing. In this embodiment, the firmware updating processing is started without a user operation. More specifically, for example, firmware updating processing is started if it is determined, based on time information that the printer 101 holds in a nonvolatile area, that it is a predetermined time or the processing is performed based on an instruction from an external server. However, the firmware updating processing may be started by a user operation. More specifically, for example, the firmware updating processing may be started based on a user operation on the operation panel (not shown) of the user interface 215 of the printer 101.

In S802, the CPU 201 of the printer 101 requests TLS connection to the firmware updating server 103. In other words, by the request of TLS connection to the firmware updating server 103, TLS communication between the printer 101 and the firmware updating server 103 is started. More specifically, for example, TLS hand shake is started by transmission processing of transmitting a ClientHello message.

In S803, the CPU 221 of the firmware updating server 103 transmits server certificate data to the printer 101 in the process of TLS hand shake.

In S804, upon receiving the server certificate data from the firmware updating server 103, the CPU 201 of the printer 101 verifies the server certificate data using root certificate data corresponding to the firmware updating server 103 held in the printer 101. Here, the root certificate data corresponding to the firmware updating server 103 held in the printer 101 may be initial root certificate data corresponding to the firmware updating server 103. Also, the root certificate data held in the printer 101 may be latest root certificate data corresponding to the firmware updating server 103 updated in S606 of FIG. 6. As the verification, for example, like S604, it is determined using the root certificate data whether the sign of the server certificate data can be trusted. Here, assume that the result of the verification of the server certificate data in S804 is determined as success.

In S805, the CPU 201 of the printer 101 acquires an updating firmware file including latest firmware data from the firmware updating server 103 by TLS communication encrypted by TLS. Note that as described above, the updating firmware file includes the root certificate data 402 and the root certificate data 403 in addition to firmware data. Thus, in this embodiment, since the updating firmware file is acquired by TLS communication, it is possible to improve security associated with acquisition of root certificate data. Also, the updating firmware file itself may be encrypted. This can further improve security associated with acquisition of root certificate data.

In S806, the CPU 201 of the printer 101 updates the firmware data using the firmware data included in the updating firmware file. In S807, the CPU 201 of the printer 101 ends the TLS connection between the printer 101 and the firmware updating server 103.

In S805 of FIG. 8, the printer 101 acquires, from the firmware updating server 103, root certificate data corresponding to the certificate distribution server 102 and root certificate data corresponding to the firmware updating server 103. In S806, the printer 101 updates the root certificate data corresponding to the certificate distribution server 102 held in the printer 101 by the root certificate data corresponding to the certificate distribution server 102 acquired in S805. Also, in S806, the printer 101 updates the root certificate data corresponding to the firmware updating server 103 held in the printer 101 by the root certificate data corresponding to the firmware updating server 103 acquired in S805. That is, in this embodiment, if the result of the verification of the server certificate data in S804 is determined as success, the printer 101 updates all root certificate data held at that time. Hence, if an external server that is not illustrated in FIG. 1 exists, root certificate data other than the two root certificate data may be updated. For example, in S805, the printer 101 may acquire, from the firmware updating server 103, root certificate data for verifying server certificate data from another content server (not shown) at the same time as the acquisition of the updating firmware file. In S806, the printer 101 may update root certificate data corresponding to the content server held in the printer 101 by the acquired root certificate data. Thus, in this embodiment, all root certificate data held in the printer 101 can be updated by updating the firmware.

Processing executed in a case where the result of verification of server certificate data is success has been described above. Processing executed in a case where the result of verification of server certificate data is failure will be described below.

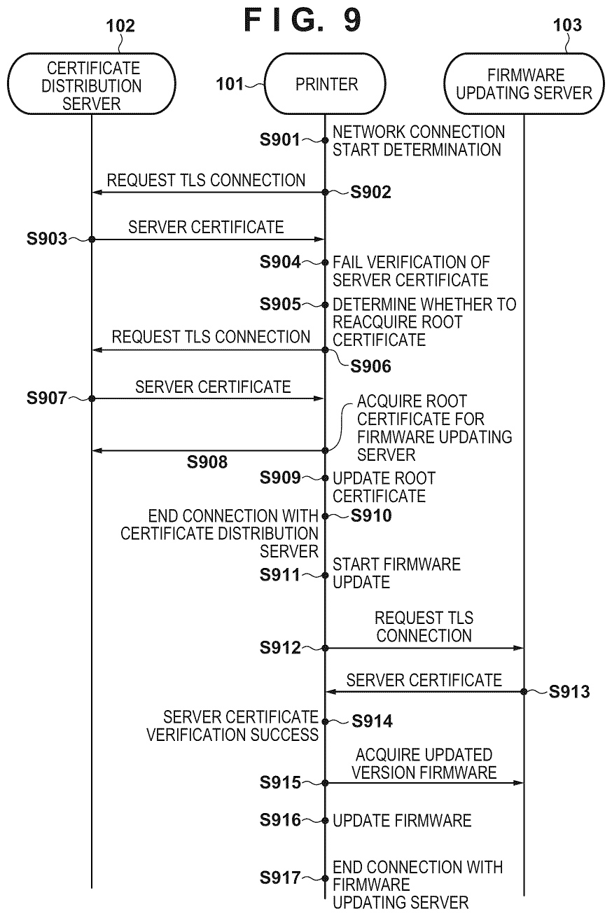

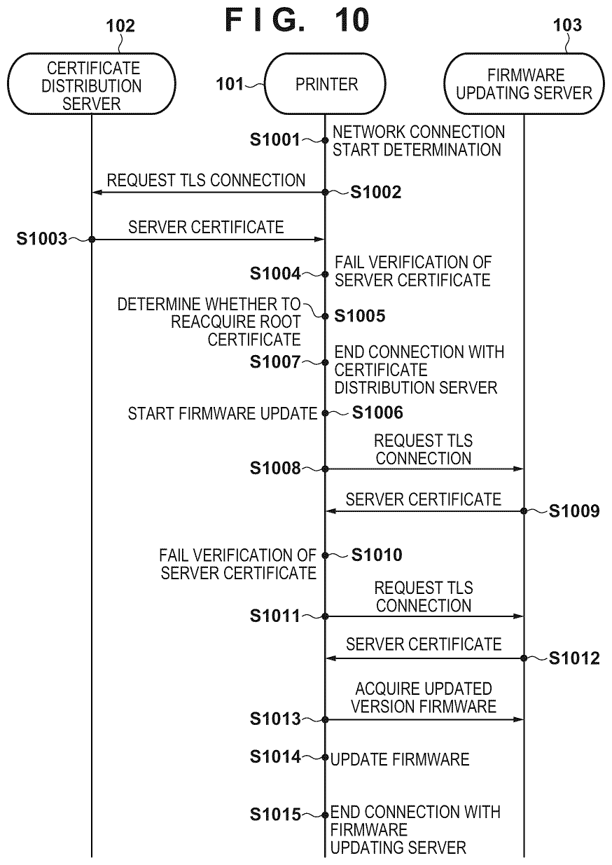

FIG. 9 is a sequence chart for explaining processing executed between the printer 101 and the certificate distribution server 102 and between the printer 101 and the firmware updating server 103. The operation of the printer 101 shown in FIG. 9 is implemented by, for example, the CPU 201 reading out a program stored in the flash ROM 202 to the RAM 203 and executing it. Also, the operation of the certificate distribution server 102 shown in FIG. 9 is implemented by, for example, the CPU 221 of the certificate distribution server 102 reading out a program stored in the flash ROM 222 to the RAM 223 and executing it. In addition, the operation of the firmware updating server 103 shown in FIG. 9 is implemented by, for example, the CPU 221 of the firmware updating server 103 reading out a program stored in the flash ROM 222 to the RAM 223 and executing it.

Processing of S901 to S904 is the same as the description of S601 to S604, and a description thereof will be omitted. Also, at least processing of S902 to S914 of FIG. 9 is processing performed even without a user operation after an operation as the factor for starting network connection is performed. However, in FIG. 9, in S904, assume that the CPU 201 of the printer 101 receives server certificate data from the certificate distribution server 102 and verifies the server certificate data using initial root certificate data, and as a result, it is determined that the verification fails (verification error). More specifically, for example, if the expiration date of the initial root certificate data corresponding to the certificate distribution server 102 held in the printer 101 is past, the result of the verification of the server certificate data from the certificate distribution server 102 is determined as failure.

In S905, the CPU 201 of the printer 101 determines whether to reacquire root certificate data. More specifically, for example, if the expiration date of initial root certificate data held in the printer 101 is past, it is determined to reacquire root certificate data. As a method of confirming the expiration date, for example, time information held in a nonvolatile area different from the area where the initial root certificate data is stored is compared with the expiration date of the initial root certificate data. At this time, for example, the time information held in the nonvolatile area may be updated using Real Time Clock (RTC) incorporated in the printer 101. Also, for example, when time information is acquired from an external apparatus, the time information in the nonvolatile area of the printer 101 may be updated.

Also, if the initial root certificate data held in the printer 101 has expired, it is determined to reacquire root certificate data. As a method of confirming expiration, for example, the CPU 201 of the printer 101 makes confirmation by accessing the server (not shown) of the certificate authority using Online Certificate Status Protocol (OCSP). Also, for example, the CPU 201 of the printer 101 may download Certificate Revocation Lists (CRL) and make confirmation by collating the serial number of a certificate registered in the CRL with the server certificate data or the initial root certificate data.

If it is determined, in S905, to reacquire root certificate data, in S906, the CPU 201 of the printer 101 requests TLS connection to the certificate distribution server 102 again. In other words, by the request of TLS connection to the certificate distribution server 102, TLS communication between the printer 101 and the certificate distribution server 102 is started again. More specifically, for example, TLS hand shake is started by transmission processing of transmitting a ClientHello message.

In S907, the certificate distribution server 102 transmits server certificate data to the printer 101 in the process of TLS hand shake. Here, the CPU 201 of the printer 101 receives the server certificate data from the certificate distribution server 102 but verification of the server certificate data is deliberately not executed. This is because if the verification of the server certificate data is executed, the verification result is determined as failure and, therefore, subsequent TLS communication for acquiring root certificate data also fails.

In S908, the CPU 201 of the printer 101 acquires root certificate data corresponding to the firmware updating server 103 from the certificate distribution server 102. Thus, in this embodiment, the CPU 201 of the printer 101 acquires latest root certificate data corresponding to the firmware updating server 103 from the certificate distribution server 102 by TLS communication encrypted by TLS. It is therefore possible to improve security associated with acquisition of root certificate data as compared to a case where it is acquired by a plain text.

In S605 of FIG. 6, root certificate data corresponding to the certificate distribution server 102 and root certificate data corresponding to the firmware updating server 103 are acquired, as described above. On the other hand, in S908, only root certificate data corresponding to the firmware updating server 103 is acquired, and root certificate data corresponding to the certificate distribution server 102 is not acquired. Note that the root certificate data acquisition target is changed by, for example, changing the URL to which the printer 101 is connected.

As will be described later, for the server certificate data transmitted from the firmware updating server 103, the CPU 201 of the printer 101 performs verification using the root certificate data acquired in S908. That is, it can be said that the risk of impersonation of the firmware updating server 103 is low. For this reason, in this embodiment, it is possible to update root certificate data corresponding to a server other than the firmware updating server 103, for example, the certificate distribution server 102 by TLS communication with the firmware updating server 103 with the low risk of impersonation.

In S909, the CPU 201 of the printer 101 updates the root certificate data corresponding to the firmware updating server 103 held in the printer 101 using the root certificate data corresponding to the firmware updating server 103 received from the certificate distribution server 102 in S908. The root certificate data here can be initial root certificate data.

In S910, the CPU 201 of the printer 101 ends the TLS connection between the printer 101 and the certificate distribution server 102.

In S911, the CPU 201 of the printer 101 starts firmware updating processing. In this embodiment, firmware updating processing is automatically started without interposing a user operation.

In S908, only root certificate data corresponding to the firmware updating server 103 is acquired, as described above. That is, root certificate data corresponding to another external server (not shown) different from the certificate distribution server 102 or the firmware updating server 103 is not acquired. Hence, root certificate data corresponding to the certificate distribution server 102 or another external server (not shown) held in the printer 101 is not updated. For this reason, if firmware updating processing of the subsequent stage is not executed, TLS communication between the printer 101 and the certificate distribution server 102 or another external server fails. Hence, in this embodiment, firmware updating processing is automatically started without interposing a user operation at the timing of S911. From then on, when the user intentionally communicates with the external server, TLS communication between the printer 101 and the external server can succeed.

In FIG. 9, firmware updating processing is started at the timing of S911, as described above. However, firmware updating processing may be started at another timing. In general, firmware updating takes long processing time as compared to updating of root certificate data. For this reason, firmware updating processing may automatically be started in, for example, a night time zone, independently of the processing shown in FIG. 9. A setting operation by the user for this may be accepted on the operation panel (not shown) of the user interface 215 of the printer 101. Alternatively, a message screen indicating that connection to the external server (not shown) is impossible may be displayed on the operation panel of the user interface 215 of the printer 101 in S910, and setting of time information at which firmware updating processing can be started may be accepted by a user operation.

When firmware updating processing is started, in S912, the CPU 201 of the printer 101 makes a request for a TLS connection to the firmware updating server 103. In other words, by the request of TLS connection to the firmware updating server 103, TLS communication between the printer 101 and the firmware updating server 103 is started. More specifically, for example, TLS hand shake is started by transmission processing of transmitting a ClientHello message.

In S913, the CPU 221 of the firmware updating server 103 transmits server certificate data to the printer 101 in the process of TLS hand shake.

In S914, upon receiving the server certificate data from the firmware updating server 103, the CPU 201 of the printer 101 verifies the received server certificate data using root certificate data corresponding to the firmware updating server 103 held in the printer 101. Here, the root certificate data corresponding to the firmware updating server 103 held in the printer 101 is the latest root certificate data updated in S909. As the verification, for example, it is determined using the initial root certificate whether the sign of the server certificate data can be trusted, like S604. Since the verification is performed using the root certificate data corresponding to the firmware updating server 103 acquired in S908, the result of the verification of the server certificate data in S914 is determined as success.

In S915, the CPU 201 of the printer 101 acquires an updating firmware file including latest firmware data from the firmware updating server 103 by TLS communication encrypted by TLS. Note that as described above, the updating firmware file includes the root certificate data 402 and the root certificate data 403 in addition to firmware data. Thus, in this embodiment, since the updating firmware file is acquired by TLS communication, it is possible to improve security associated with acquisition of root certificate data. Also, the updating firmware file itself may be encrypted. This can further improve security associated with acquisition of root certificate data.

In S916, the CPU 201 of the printer 101 updates the firmware using the firmware data included in the updating firmware file. In S917, the CPU 201 of the printer 101 ends the TLS connection between the printer 101 and the firmware updating server 103

In S915 of FIG. 9, the printer 101 acquires, from the firmware updating server 103, root certificate data corresponding to the certificate distribution server 102 and root certificate data corresponding to the firmware updating server 103. In S916, the printer 101 updates the root certificate data corresponding to the certificate distribution server 102 held in the printer 101 by the root certificate data corresponding to the certificate distribution server 102 acquired in S915. Also, in S916, the printer 101 updates the root certificate data corresponding to the firmware updating server 103 held in the printer 101 by the root certificate data corresponding to the firmware updating server 103 acquired in S915. That is, in this embodiment, if the result of the verification of the server certificate data in S914 is determined as success, the printer 101 updates all root certificate data held at that time. Hence, if an external server that is not illustrated in FIG. 1 exists, root certificate data other than the root certificate data corresponding to the certificate distribution server 102 and the root certificate data corresponding to the firmware updating server 103 may be updated. For example, in S915, the printer 101 may acquire, from the firmware updating server 103, root certificate data for verifying server certificate data from another content server (not shown). In S916, the printer 101 may update initial root certificate data corresponding to the content server held in the printer 101 by the acquired root certificate data. Thus, in this embodiment, all root certificate data held in the printer 101 are updated by updating the firmware. As a result, TLS communication between the printer 101 and external servers including the certificate distribution server 102 after execution of firmware updating processing can be prevented from failing.

Processing different from that in FIG. 9, which is executed in a case where the result of verification of server certificate data is failure, will be described next.

FIG. 10 is a sequence chart for explaining processing executed between the printer 101 and the certificate distribution server 102 and between the printer 101 and the firmware updating server 103. The operation of the printer 101 shown in FIG. 10 is implemented by, for example, the CPU 201 reading out a program stored in the flash ROM 202 to the RAM 203 and executing it. Also, the operation of the certificate distribution server 102 shown in FIG. 10 is implemented by, for example, the CPU 221 of the certificate distribution server 102 reading out a program stored in the flash ROM 222 to the RAM 223 and executing it. In addition, the operation of the firmware updating server 103 shown in FIG. 10 is implemented by, for example, the CPU 221 of the firmware updating server 103 reading out a program stored in the flash ROM 222 to the RAM 223 and executing it.

Processing of S1001 to S1005 is the same as the description of S901 to S905, and a description thereof will be omitted. Also, at least processing of S1002 to S1012 of FIG. 10 is processing performed even without a user operation after an operation as the factor for starting network connection is performed. In FIG. 10, assume a case where in determination processing of determining whether to reacquire root certificate data in S1005, it is determined not to reacquire root certificate data. More specifically, for example, in a case where conditions that root certificate data should be updated because of, for example, expiration of initial root certificate data held in the printer 101 and server certificate data from the certificate distribution server 102 has also expired are satisfied, it is determined not to reacquire root certificate data.

In S1006, the CPU 201 of the printer 101 ends the TLS connection between the printer 101 and the certificate distribution server 102.

In S1007, the CPU 201 of the printer 101 starts firmware updating processing. In this embodiment, firmware updating processing is automatically started without interposing a user operation. However, firmware updating processing may be started not automatically but by a user operation.

When firmware updating processing is started, in S1008, the CPU 201 of the printer 101 requests TLS connection to the firmware updating server 103. In other words, by the request of TLS connection to the firmware updating server 103, TLS communication between the printer 101 and the firmware updating server 103 is started. More specifically, for example, TLS hand shake is started by transmission processing of transmitting a ClientHello message.

In S1009, the CPU 221 of the firmware updating server 103 transmits server certificate data to the printer 101 in the process of TLS hand shake.

In S1010, upon receiving the server certificate data from the firmware updating server 103, the CPU 201 of the printer 101 verifies the server certificate data received from the firmware updating server 103 using root certificate data held in the printer 101. As the verification, for example, it is determined using the root certificate data held in the printer 101 whether the sign of the server certificate data can be trusted.

If the result of the verification of the server certificate data is determined as success, the CPU 201 of the printer 101 acquires an updating firmware file including latest firmware data from the firmware updating server 103 by TLS communication encrypted by TLS, as in FIG. 9. Then, as in FIG. 9, the CPU 201 of the printer 101 updates the firmware using the firmware data included in the updating firmware file, and, ends the TLS connection between the printer 101 and the firmware updating server 103. Note that although the processes are not illustrated in FIG. 10, the same processes as in S915 to S917 of FIG. 9 are performed.

Here, assume that the result of the verification of the server certificate data from the firmware updating server 103 is determined as failure. More specifically, for example, if the initial root certificate data corresponding to the firmware updating server 103 held in the printer 101 has expired, the result of the verification of the server certificate data is determined as failure.

In S1011, the CPU 201 of the printer 101 requests TLS connection to the firmware updating server 103. In other words, by the request of TLS connection to the firmware updating server 103, TLS communication between the printer 101 and the firmware updating server 103 is started again. More specifically, for example, TLS hand shake is started by transmission processing of transmitting a ClientHello message.

In S1012, the CPU 221 of the firmware updating server 103 transmits server certificate data to the printer 101 in the process of TLS hand shake. Here, the CPU 201 of the printer 101 receives the server certificate data from the firmware updating server 103 but verification of the server certificate data is deliberately not executed. This is because if the verification of the server certificate data is executed, the verification result is determined as failure and, therefore, subsequent TLS communication for acquiring the updating firmware file also fails.

In S1013, the CPU 201 of the printer 101 acquires an updating firmware file including latest firmware data from the firmware updating server 103 by TLS communication encrypted by TLS. Note that as described above, the updating firmware file includes the root certificate data 402 and the root certificate data 403 in addition to firmware data. Thus, in this embodiment, since the updating firmware file is acquired by TLS communication, it is possible to improve security associated with acquisition of root certificate data. Also, the updating firmware file itself may be encrypted. This can further improve security associated with acquisition of root certificate data.

In S1014, the CPU 201 of the printer 101 updates the firmware using the firmware data included in the updating firmware file. In S1015, the CPU 201 of the printer 101 ends the TLS connection between the printer 101 and the firmware updating server 103.

As described above, according to this embodiment, the printer 101 uses TLS communication as communication when acquiring root certificate data, thereby improving confidentiality and integrity. In addition, since root certificate data is acquired without interposing a user operation, it is possible to improve convenience.

Note that the above-described various kinds of control performed by the CPU may be performed by one piece of hardware, or a plurality of pieces of hardware (for example, a plurality of processors or circuits) may share the processing to control the entire apparatus.

The present disclosure has been described above in detail based on the preferred embodiments. However, the present disclosure is not limited to these specific embodiments and can incorporate various forms without departing from the scope of the present disclosure. The above-described embodiments are merely examples of the present disclosure and can also appropriately be combined.

Also, in the above-described embodiment, an example in which the present disclosure is applied to a printer has been described. However, the present disclosure is not limited to this example and can be applied to any apparatus capable of communicating with the certificate distribution server 102 and the firmware updating server 103. That is, the present disclosure can be applied to a personal computer, a PDA, a portable telephone terminal, a portable image viewer, a printer apparatus with a display, a digital photo frame, a music player, a game machine, an electronic book reader, and the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-182172, filed Oct. 17, 2024 which is hereby incorporated by reference herein in its entirety.

What is claimed is:

1. An electronic device comprising
at least one memory and at least one processor which function as
a control unit configured to, in a case where connection between the electronic device and a first server outside the electronic device is to be started, control to execute first transmission processing of transmitting, to the first server, information for requesting start of communication by a predetermined protocol for performing encrypted communication, and
if the communication by the predetermined protocol is started between the electronic device and the first server based on the first transmission processing, control to execute first reception processing of receiving, from the first server, second root certificate data for verifying certificate data from a second server different from the first server even without an operation from a user after execution of the first transmission processing.

2. The device according to claim 1, wherein the at least one memory and the at least one processor further function as an accepting unit configured to accept a specific operation as a factor for starting network connection,
wherein the control unit controls to perform the first transmission processing in accordance with acceptance of the specific operation.

3. The device according to claim 2, wherein the specific operation is at least one of an operation of powering on the electronic device in a state in which the network connection is enabled and an operation of changing a setting from a state in which the network connection is disabled to the state in which the network connection is enabled in the electronic device.

4. The device according to claim 1, wherein the at least one memory and the at least one processor further function as a storage unit configured to store first root certificate data for verifying certificate data from the first server,
wherein if the communication by the predetermined protocol is started between the electronic device and the first server based on the first transmission processing, the control unit verifies the certificate data from the first server using the first root certificate data stored in the storage unit.

5. The device according to claim 4, wherein
if a result of the verification of the certificate data from the first server is success, in the first reception processing, the first root certificate data for verifying the certificate data from the first server is received from the first server, and
the control unit controls to update the first root certificate data stored in the storage unit by the first root certificate data received from the first server.

6. The device according to claim 5, wherein in the first reception processing, the second root certificate data is received from the first server.

7. The device according to claim 6, wherein
the storage unit stores the second root certificate data for verifying the certificate data from the second server, and
the control unit controls to update the second root certificate data stored in the storage unit by the second root certificate data received from the first server.

8. The device according to claim 6, wherein
the storage unit stores third root certificate data for verifying certificate data from a third server that is different from the first server and different from the second server,
in the first reception processing, the third root certificate data for verifying the certificate data from the third server is received, and
the control unit controls to update the third root certificate data stored in the storage unit by the third root certificate data received from the first server.

9. The device according to claim 5, wherein
if the result of the verification of the certificate data from the first server is failure, the control unit controls to execute the first transmission processing again, and if the communication by the predetermined protocol is started again between the electronic device and the first server based on the first transmission processing, the control unit does not verify the certificate data from the first server.

10. The device according to claim 9, wherein in the first reception processing in a case where the communication by the predetermined protocol is started again, the first root certificate data for verifying the certificate data from the first server is not received from the first server.

11. The device according to claim 10, wherein in the first reception processing in a case where the communication by the predetermined protocol is started again, the second root certificate data is received from the first server.

12. The device according to claim 11, wherein
the storage unit stores the second root certificate data, and
the control unit controls to update the second root certificate data stored in the storage unit by the second root certificate data received from the first server.

13. The device according to claim 9, wherein if the result of the verification of the certificate data from the first server is failure and a condition is satisfied, the control unit controls to execute the first transmission processing again.

14. The device according to claim 13, wherein the condition includes that an expiration date of the first root certificate data stored in the storage unit is past.

15. The device according to claim 9, wherein if the result of the verification of the certificate data from the first server is failure and a condition is satisfied, the control unit controls not to execute the first transmission processing again and to end connection between the electronic device and the first server.

16. The device according to claim 15, wherein the condition includes that an expiration date of the certificate data from the first server is past.

17. The device according to claim 4, wherein to start connection between the electronic device and the second server, the control unit controls to execute second transmission processing of transmitting, to the second server, information for requesting start of communication by the predetermined protocol.

18. The device according to claim 17, wherein if the communication by the predetermined protocol is started between the electronic device and the second server based on the second transmission processing, the control unit controls to execute second reception processing of receiving, from the second server, data for updating software stored in the electronic device.

19. The device according to claim 18, wherein
the storage unit stores the second root certificate data, and
if the communication by the predetermined protocol is started between the electronic device and the second server based on the second transmission processing, the control unit verifies the certificate data from the second server using the second root certificate data stored in the storage unit.

20. The device according to claim 19, wherein
if a result of the verification of the certificate data from the second server is success, the first root certificate data for verifying the certificate data from the first server is received from the second server by reception of the data in the second reception processing, and
the control unit controls to update the first root certificate data stored in the storage unit by the first root certificate data received from the second server.

21. The device according to claim 20, wherein
the second root certificate data is received from the second server by reception of the data in the second reception processing, and
the control unit controls to update the second root certificate data stored in the storage unit by the second root certificate data received from the second server.

22. The device according to claim 20, wherein
the storage unit stores third root certificate data for verifying certificate data from a third server that is different from the first server and different from the second server,
by reception of the data in the second reception processing, the third root certificate data is received, and
the control unit controls to update the third root certificate data stored in the storage unit by the third root certificate data received from the second server.

23. The device according to claim 20, wherein
if the result of the verification of the certificate data from the second server is failure, the control unit controls to execute the second transmission processing again, and
if the communication by the predetermined protocol is started again between the electronic device and the second server based on the second transmission processing, the control unit controls to execute the second reception processing without verifying the certificate data from the second server.

24. The device according to claim 1, wherein the electronic device is a printer.

25. The device according to claim 1, wherein the communication by the predetermined protocol is communication using Transport Layer Security (TLS).

26. A control method executed in an electronic device, comprising:
in a case where connection between the electronic device and a first server outside the electronic device is to be started, controlling to execute first transmission processing of transmitting, to the first server, information for requesting start of communication by a predetermined protocol for performing encrypted communication; and
if the communication by the predetermined protocol is started between the electronic device and the first server based on the first transmission processing, controlling to execute first reception processing of receiving, from the first server, second root certificate data for verifying certificate data from a second server different from the first server even without an operation from a user after execution of the first transmission processing.

27. A non-transitory computer-readable storage medium that stores one or more programs including instructions, which when executed by one or more processors of an electronic device, cause the electronic device to:
in a case where connection between the electronic device and a first server outside the electronic device is to be started, control to execute first transmission processing of transmitting, to the first server, information for requesting start of communication by a predetermined protocol for performing encrypted communication; and
if the communication by the predetermined protocol is started between the electronic device and the first server based on the first transmission processing, control to execute first reception processing of receiving, from the first server, second root certificate data for verifying certificate data from a second server different from the first server even without an operation from a user after execution of the first transmission processing.
